(19) United States
(12) Patent Application Publication
(10) Pub. No.: US 2014/0064538 A1
(43) Pub. Date: Mar. 6, 2014

(54) CLUTCH SPEAKER

(71) Applicant: Stelle LLC, Newport Beach, CA (US)

(72) Inventors: Wayne Ludlum, Fountain Valley, CA (US); David Cox, San Clemente, CA (US); QH Liu, Guangzhou (CN)

(73) Assignee: Stelle LLC, Newport Beach, CA (US)

(21) Appl. No.: 13/843,638

(22) Filed: Mar. 15, 2013

Related U.S. Application Data
(60) Provisional application No. 61/761,652, filed on Feb. 6, 2013.
(60) Provisional application No. 61/697,259, filed on Sep. 5, 2012.

(51) Int. Cl. H04R 1/02

(52) U.S. Cl. CPC H04R 1/02
USPC 381/334

(57) ABSTRACT

A clutch speaker system includes top and bottom sides, a speaker enclosure with a speaker and first and second flexible side wings. The top side and speaker enclosure are hingedly affixed to the bottom side, and the speaker enclosure is slideably engaged with the top side, forming a hinged clutch with left and right sides and an interior. The first flexible side wing is disposed along the left side of the hinged clutch and is affixed along the left edge of the top and bottom sides to form a first flexible interface. The second flexible side wing is disposed along the right side of the clutch and is affixed along the right edge of the top and bottom sides to form a second flexible interface. The speaker enclosure includes a firing port that is directed into the interior of the hinged clutch. The speaker is positioned opposite the firing port.

### CROSS REFERENCE TO RELATED APPLICATIONS

This application claims the benefit of U.S. Provisional Patent Application No. 61/697,259, filed on Sep. 5, 2012, and U.S. Provisional Patent Application No. 61/761,652, filed on Feb. 6, 2013, the entireties of which are incorporated herein by reference.

### FIELD OF THE INVENTION

The present invention relates to an improved, compact and foldable, self-contained clutch speaker system.

### BACKGROUND OF THE INVENTION

In the field of sound reproduction, it is desirable to have speaker system that exists as a stand alone or single device or unit, such that it can be readily set up, moved, or transported, preferably as a clutch. However, existing portable speaker systems do not typically contain quality sound reproduction, and their designs often do not lend themselves to being moved or transported in a compact manner, as with a clutch or similar item that can easily be carried. Accordingly, a need exists for a compact and foldable, self-contained clutch speaker system, where the design of the speaker system lends itself to quality sound production.

### SUMMARY OF THE PREFERRED EMBODIMENTS

In a preferred embodiment, the clutch speaker system of the present invention includes a top side, having a front edge, a rear edge, a right edge, and a left edge; a bottom side, having a front edge, a rear edge, a right edge, and a left edge; a speaker enclosure, including at least one speaker, the speaker enclosure having a top edge, a bottom edge, a right edge, and a left edge; and a first flexible side wing and a second flexible side wing. The rear edge of the top side is hingedly affixed to the rear edge of the bottom side, the bottom edge of the speaker enclosure is hingedly affixed to the front edge of the bottom side, and the top edge of the speaker enclosure is slideably engaged with the top side, forming a hinged clutch, the hinged clutch having a left side and a right side and an interior space. The first flexible side wing is generally disposed along the left side of the hinged clutch, the first flexible side wing being affixed along the left edge of the top side and along the left edge of the bottom side, forming a first flexible interface that is generally adjacent and parallel to the left edge of the speaker enclosure. The second flexible side wing is generally disposed along the right side of the hinged clutch, the second flexible side wing being affixed along the right edge of the top side and along the right edge of the bottom side, forming a second flexible interface that is generally adjacent and parallel to the right edge of the speaker enclosure. The speaker enclosure includes at least one firing port, the at least one firing port being directed into the interior space of the hinged clutch, and the at least one speaker being positioned on a side of the speaker enclosure opposite the side of the at least one firing port.

In a preferred embodiment of the present invention, the hinged clutch is spring loaded. Preferably, a clasp is affixed to the front edge of either of the top side or the bottom side. Preferably, the clutch speaker system comprises at least one audio input port. Preferably, the speaker enclosure includes two speakers. Preferably, the clutch speaker system comprises at least one audio output port. Preferably, the first flexible side wing and the second flexible side wing are comprised of plastic. In another preferred embodiment, the first flexible side wing and the second flexible side wing are comprised of leather. In another preferred embodiment, the top side and the bottom side are comprised of plastic. In another preferred embodiment, the top side and the bottom side are comprised of metal. In another preferred embodiment, a powered amplifier is attached to the hinged clutch and located within the interior space of the hinged clutch. Preferably, the powered amplifier is connected to the two speakers.

In accordance with another aspect of the present invention, a clutch speaker system is provided that is comprised of a top side, having a front edge, a rear edge, a right edge, and a left edge; a bottom side, having a front edge, a rear edge, a right edge, and a left edge; a speaker enclosure, including at least one speaker, the speaker enclosure having a top edge, a bottom edge, a right edge, and a left edge. The rear edge of the top side is hingedly affixed to the rear edge of the bottom side, the bottom edge of the speaker enclosure is hingedly affixed to the front edge of the bottom side, and the top edge of the speaker enclosure is slideably engaged with the top side, forming a hinged clutch, the hinged clutch having a left side and a right side and an interior space.

In a preferred embodiment of the present invention, the clutch speaker system further comprises a first flexible side wing and a second flexible side wing. Preferably, a clasp is affixed to the front edge of either of the top side or the bottom side. Preferably, the hinged clutch is spring loaded. Preferably, the speaker enclosure includes two speakers. Preferably, a powered amplifier is attached to the hinged clutch and located within the interior space of the hinged clutch. Preferably, the powered amplifier is connected to the two speakers.

### BRIEF DESCRIPTION OF THE DRAWINGS

FIG. 1 is a front perspective view of a clutch speaker system in accordance with a preferred embodiment of the present invention, where the clutch speaker system is shown in an open state;

FIG. 2 is a front perspective view of the clutch speaker system of FIG. 1, where the clutch speaker system is shown in a closed state;

FIG. 3 is a front elevation view of the clutch speaker system of FIGS. 1 and 2;

FIG. 4 is a side elevation view of the clutch speaker system of FIGS. 1 and 2;

FIG. 5 is a top plan view of the clutch speaker system of FIGS. 1 and 2;

FIG. 6 is a bottom plan view of the clutch speaker system of FIGS. 1 and 2;

FIG. 7 is a perspective view of the clutch speaker system of FIGS. 1 and 2, showing flexible side wings in place;

FIG. 8 is a front elevation view of the clutch speaker system of FIGS. 1 and 2, showing flexible side wings in place; and

FIG. 9 is a rear perspective view of the clutch speaker system of FIGS. 1 and 2, showing the interior detail that includes a rear firing port.

FIG. 10 is a rear perspective view of the clutch speaker system of FIGS. 1 and 2, showing interior detail of the clutch speaker system.

### DETAILED DESCRIPTION OF THE PREFERRED EMBODIMENTS

The following description and drawings are illustrative and are not to be construed as limiting. Numerous specific details are described to provide a thorough understanding of the disclosure. However, in certain instances, well-known or conventional details are not described in order to avoid obscuring the description. References to one or an embodiment in the present disclosure can be, but are not necessarily, references to the same embodiment; and, such references are intended to refer to at least one of the embodiments. Unless otherwise stated, like numerals within the figures refer to the same or similar features or aspects of the present invention, as among all figures.

Reference in this specification to “one embodiment” or “an embodiment” means that a particular feature, structure, or characteristic described in connection with the embodiment is included in at least one embodiment of the disclosure. The appearances of the phrase “in one embodiment” in various places in the specification are not necessarily all referring to the same embodiment, nor are separate or alternative embodiments mutually exclusive of other embodiments. Moreover, various features are described which may be exhibited by some embodiments and not by others. Similarly, various requirements are described which may be requirements for some embodiments but not other embodiments.

The terms used in this specification generally are intended to have their ordinary meanings in the art, within the context of the disclosure, and in the specific context where each term is used. Certain terms that are used to describe the disclosure are discussed below, or elsewhere in the specification, to provide additional guidance to one of skill in the art regarding the description of the disclosure. For convenience, certain terms may be highlighted, for example using italics and/or quotation marks. The use of any such highlighting has no influence on the scope and meaning of a term; the scope and meaning of a term is the same, in the same context, whether or not it is highlighted.

It will be appreciated that the same thing can be said in more than one way. Consequently, alternative language and synonyms may be used for any one or more of the terms discussed herein. No special significance is to be placed upon whether or not a term is elaborated or discussed herein. Synonyms for certain terms are provided. A recital of one or more synonyms does not exclude the use of other synonyms. The use of examples anywhere in this specification including examples of any terms discussed herein is illustrative only, and is not intended to further limit the scope and meaning of the disclosure or of any exemplified term. Likewise, the disclosure is not limited to various embodiments given in this specification.

Without intent to further limit the scope of the disclosure, examples of instruments, apparatus, methods and their related results according to the embodiments of the present disclosure are given below. Note that titles or subtitles may be used in the examples for convenience of a reader, which in no way should limit the scope of the disclosure. Unless otherwise defined, all technical and scientific terms used herein have the same meaning as commonly understood by one of ordinary skill in the art to which this disclosure pertains. In the case of conflict, the present document, including definitions, will control.

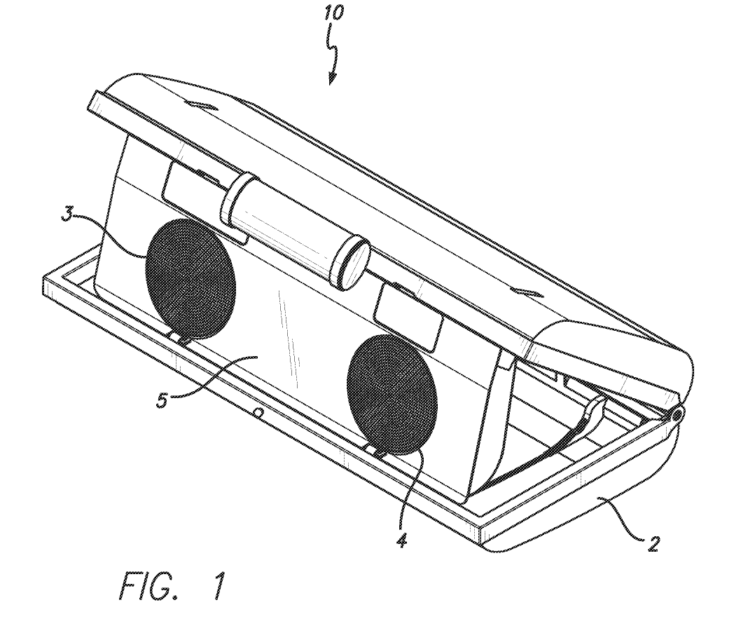

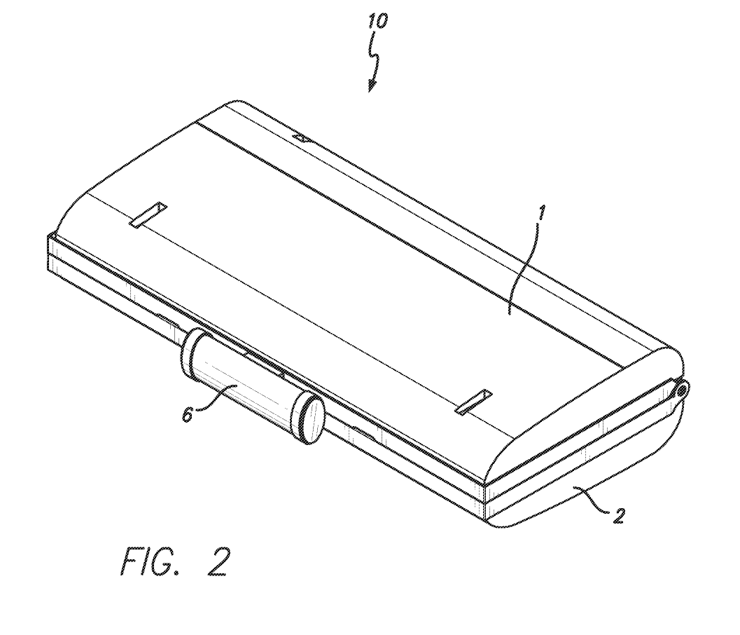

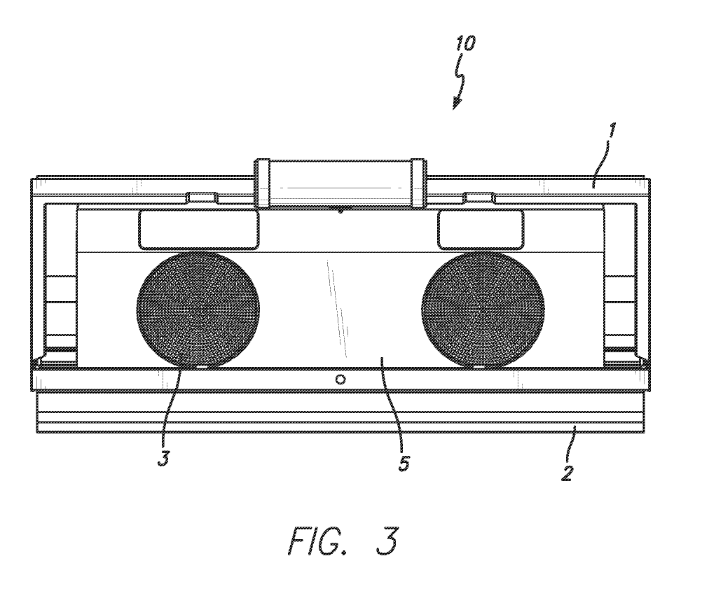

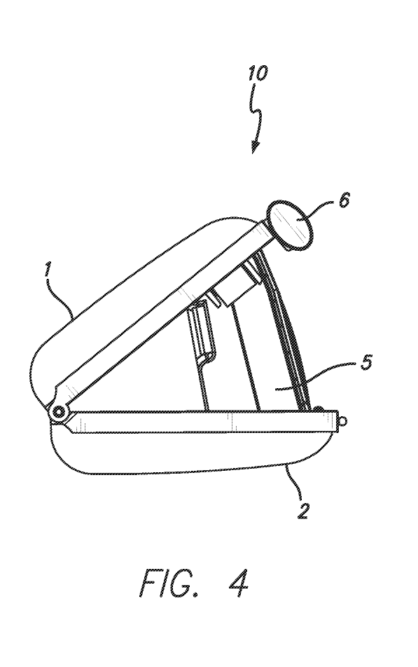

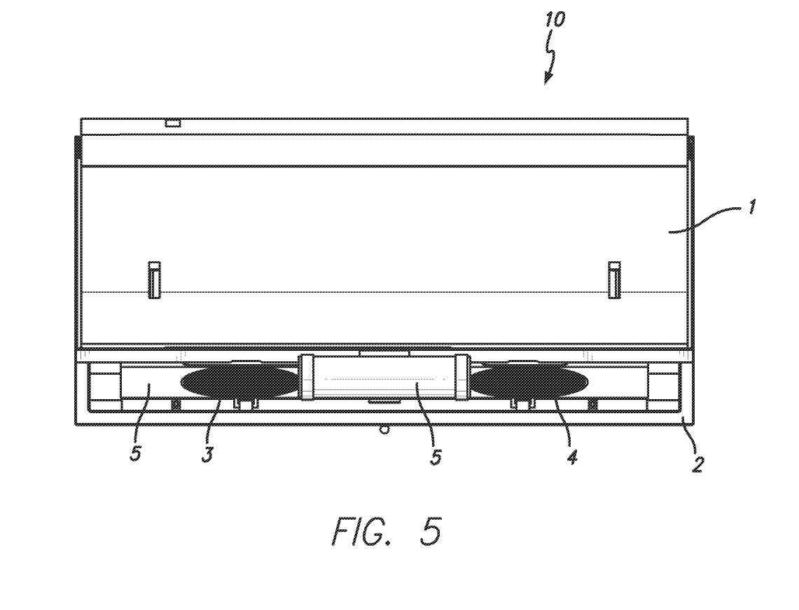

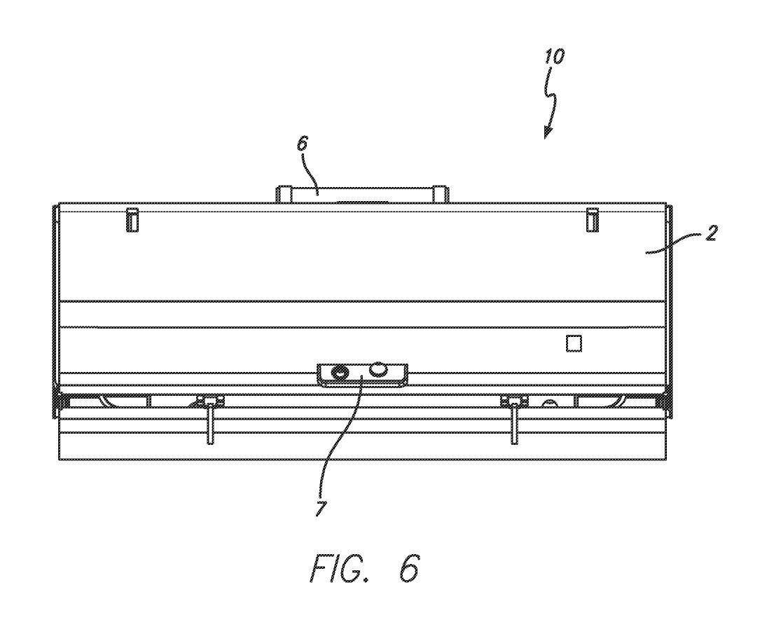

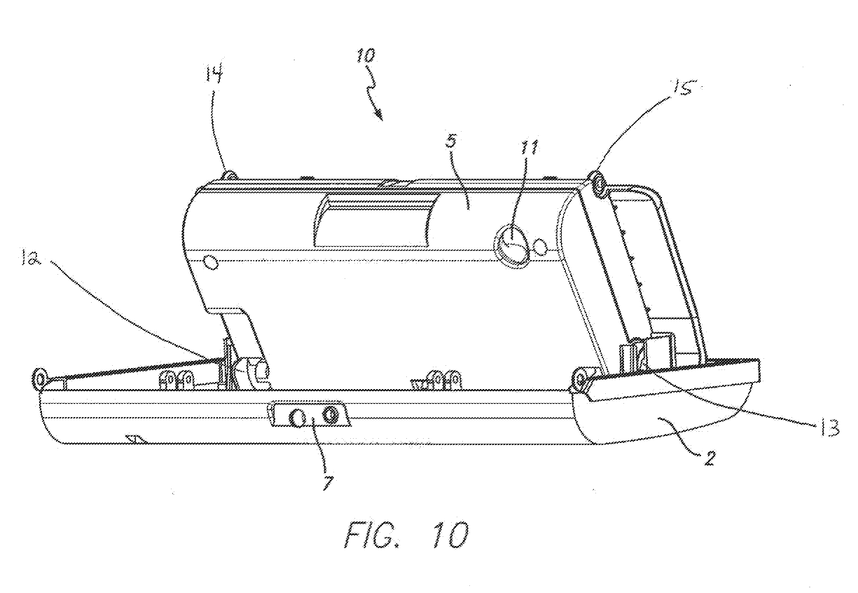

Disclosed herein is a clutch, purse, or bag with one more speakers hingedly connected therein. A preferred embodiment of a clutch speaker system 10 is shown in the accompanying FIGS. 1 through 10. The clutch speaker system 10 has two sides, a top side 1 and a bottom side 2, that are hingedly connected or folded over one another. Hinges 12 and 13 can be seen in FIG. 10. A set of speakers 3 and 4 are mounted on a moveable speaker enclosure 5 (as can be seen in FIGS. 1, 9, and 10), which moveable speaker enclosure 5 is pivotally disposed in between the top side 1 and bottom side 2, as can be seen in FIG. 1. The bottom portion of moveable speaker enclosure 5 is connected by way of hinges 12 and 13, or other similar connections, to the front, upper portion of bottom lid 2, as can be seen in FIGS. 1 and 10. The top portion of moveable speaker enclosure 5 is slideably engaged with the top side 1, such that when the top side 1 is closed, the top portion of the moveable speaker enclosure 5 rotates and slides in a rearward direction, while the bottom portion of moveable speaker enclosure 5 pivots about the one or more hinges (or other similar connections), until the entire device is in a closed state, as can be seen in FIG. 2. This can be accomplished and/or facilitated by way of rollers 14 and 15, as shown in FIG. 10, or by other mechanisms readily apparent to those of skill in the art.

While speakers 3 and 4 are mounted to moveable speaker enclosure 5, it is contemplated and intended to be within the scope of the present invention to include a radio or any type of audio or video player or device on moveable speaker enclosure 5, either alone or in combination with one or more speakers. In another preferred embodiment, a radio or any type of audio or video player or device is attached to other surfaces within the interior of the clutch space. When the top side 1 and bottom side 2 are separated or hinged apart (e.g., the clutch is opened), the moveable speaker enclosure 5 (and correspondingly, speakers 3 and 4), pivot away from the bottom side 2 and span the space between the now separated top side 1 and bottom side 2, such that the clutch speaker system is in an open state (as can be seen in FIG. 1).

Clutch speaker system 10 may have a clasp 6, or any combination or types of locking mechanisms, to keep and maintain the clutch speaker system 10 in a closed state. One or more springs or other elastic elements may be used to “spring load” top side 1 and bottom side 2, such that when the clutch speaker system 10 is in a closed state and the clasp 6 is released, the clutch speaker system 10 automatically opens under the force of the one or more springs or other elastic elements. Input/output ports 7 are used to connect an input cable to the speakers and/or other audio or video players or devices that may be attached within the interior clutch space. In another preferred embodiment, speakers 3 and 4 may be powered by one or more amplifiers that are attached within the interior clutch space or the moveable speaker enclosure 5. In such a preferred embodiment, input/output ports 7 may include a power cable input. Input/output port 7 also may include an output port that would allow an audio or visual signal to pass out through a connected cable.

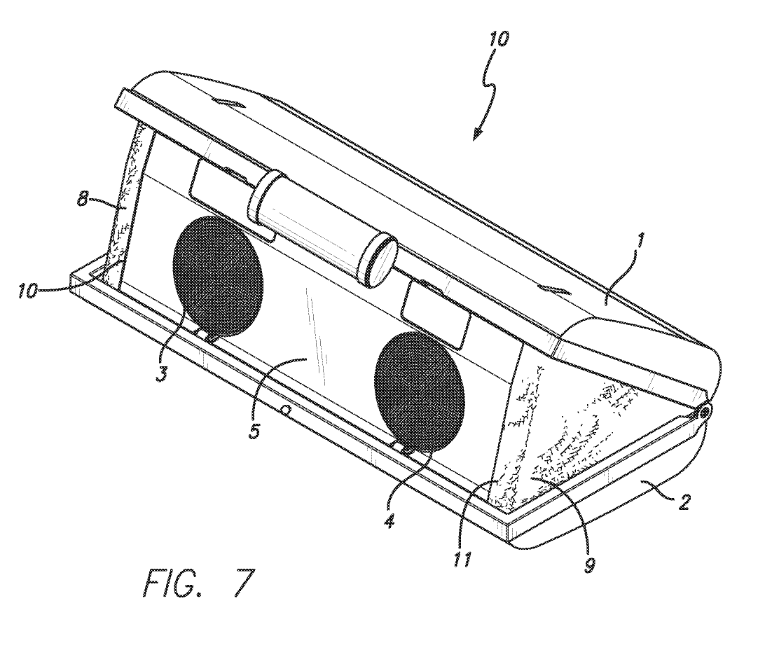

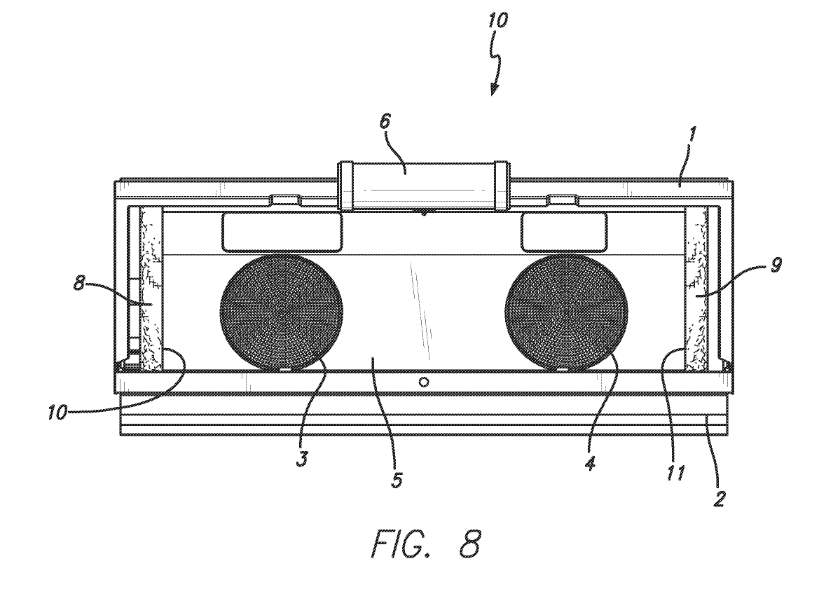

Referring now to FIGS. 7 and 8, in a preferred embodiment of the clutch speaker system 10, flexible side wings 8 and 9 are disposed along the left and right sides, respectively, of the clutch speaker system 10. Flexible side wing 8 is disposed along the left side of clutch speaker system 10 in a similar or identical manner as flexible side wing 9, as shown in FIG. 7. The portions of flexible side wings 9 and 10 that are immediately adjacent to moveable speaker enclosure 5 are not connected to moveable speaker enclosure 5 or otherwise to any other portion of clutch speaker system 10. As such, these portions of flexible side wings 9 and 10 form flexible interfaces 10 and 11. However, all other portions of flexible side wings 9 and 10 are connected to the clutch speaker system 10. Specifically, as can be seen in FIG. 7, the upper portions of flexible side wings 8 and 9 are connected to the top side 1 along the lateral edges of top side 1, and the lower portions of flexible side wings 8 and 9 are connected to the bottom side 2 along the lateral edges of bottom side 2, as can be seen in FIG. 7. Preferably, flexible side wings 8 and 9 are continuously connected (more preferably, sealed in a continuous manner) along the lateral edges of the top side 1 and bottom side 2. Because the flexible side wings 8 and 9 are pliable and otherwise foldable, when the clutch speaker system 10 is placed into a closed state (as shown in FIG. 2), the flexible side wings readily collapse and become tucked within the interior space of the clutch speaker system 10.

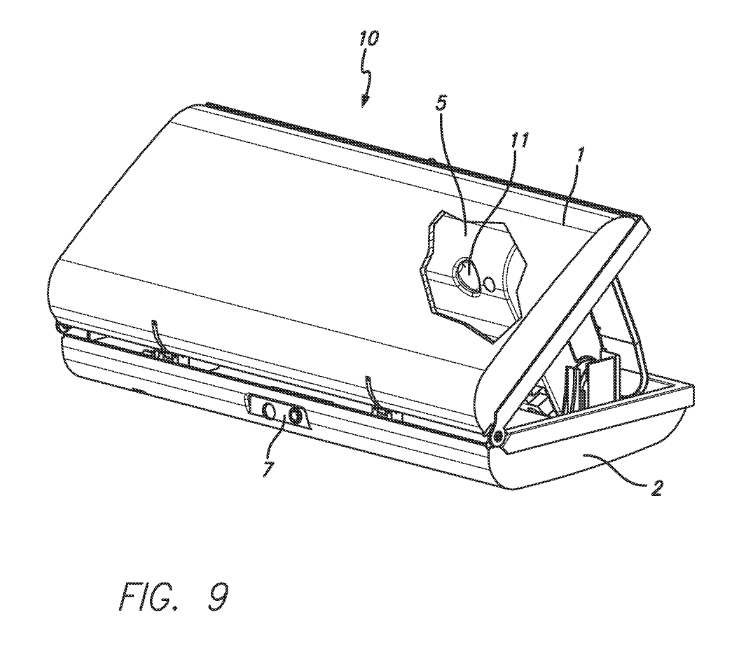

Referring now to FIGS. 9 and 10, moveable speaker enclosure 5 has at least one rear firing port 11, which rear firing port 11 is exited into the interior space of the clutch speaker system 10 to create a dampened enclosure. As described above, the flexible interfaces 10 and 11 of each of flexible side wings 8 and 9 are disconnected from the enclosure so as to allow air to pass through, at about and along the vertical lines of interfaces 10 and 11, as can be seen and understood in FIGS. 7 and 8.

In operation, the sound pressure created from the rear firing port 11 and driver acoustic cavity that is released into the interior space of the clutch speaker system 10 is then fired out flexible side wings 8 and 9 through flexible interfaces 10 and 11. This approach allows the use of port pressure inside an enclosure to create a radiator effect, thus increasing low frequency response created by the standing waves exiting the acoustic chamber of the two high frequency drivers. While most portable or compact speaker systems known in the prior art take energy produced by porting and fire out the front (and thus wasting the acoustical effect of the compressed frequency response produced by the drivers creating the energy), here, rear firing port 11 that exits into the interior space of the clutch speaker system 10, together with the flexible side wings 8 and 9 and flexible interfaces 10 and 11, create the desired radiator effect. Flexible side wings 8 and 9 are intended to be constructed from leather or plastic. In addition, any other flexible material within the knowledge of one of skill in the art is contemplated and intended to be used for flexible side wings 8 and 9.

Unless the context clearly requires otherwise, throughout the description and the claims, the words “comprise,” “comprising,” and the like are to be construed in an inclusive sense, as opposed to an exclusive or exhaustive sense; that is to say, in the sense of “including, but not limited to.” As used herein, the terms “connected,” “coupled,” or any variant thereof, means any connection or coupling, either direct or indirect, between two or more elements; the coupling of connection between the elements can be physical, logical, or a combination thereof. Additionally, the words “herein,” “above,” “below,” and words of similar import, when used in this application, shall refer to this application as a whole and not to any particular portions of this application. Where the context permits, words in the above Detailed Description of the Preferred Embodiments using the singular or plural number may also include the plural or singular number respectively. The word “or” in reference to a list of two or more items, covers all of the following interpretations of the word: any of the items in the list, all of the items in the list, and any combination of the items in the list.

The above-detailed description of embodiments of the disclosure is not intended to be exhaustive or to limit the teachings to the precise form disclosed above. While specific embodiments of and examples for the disclosure are described above for illustrative purposes, various equivalent modifications are possible within the scope of the disclosure, as those skilled in the relevant art will recognize Further, any specific numbers noted herein are only examples: alternative implementations may employ differing values, measurements or ranges.

The teachings of the disclosure provided herein can be applied to other systems, not necessarily the system described above. The elements and acts of the various embodiments described above can be combined to provide further embodiments. Any measurements described or used herein are merely exemplary and not a limitation on the present.

While the above description describes certain embodiments of the disclosure, and describes the best mode contemplated, no matter how detailed the above appears in text, the teachings can be practiced in many ways. Details of the system may vary considerably in its implementation details, while still being encompassed by the subject matter disclosed herein. As noted above, particular terminology used when describing certain features or aspects of the disclosure should not be taken to imply that the terminology is being redefined herein to be restricted to any specific characteristics, features or aspects of the disclosure with which that terminology is associated. In general, the terms used in the following claims should not be construed to limit the disclosures to the specific embodiments disclosed in the specification unless the above Detailed Description of the Preferred Embodiments section explicitly defines such terms. Accordingly, the actual scope of the disclosure encompasses not only the disclosed embodiments, but also all equivalent ways of practicing or implementing the disclosure under the claims.

Although exemplary embodiments of the invention have been shown and described, it is to be understood that all the terms used herein are descriptive rather than limiting, and that many changes, modifications, and substitutions may be made by one having ordinary skill in the art without departing from the spirit and scope of the invention.

What is claimed is:

1. A clutch speaker system comprising:
a top side, having a front edge, a rear edge, a right edge, and a left edge;
a bottom side, having a front edge, a rear edge, a right edge, and a left edge;
a speaker enclosure, including at least one speaker, the speaker enclosure having a top edge, a bottom edge, a right edge, and a left edge;
a first flexible side wing and a second flexible side wing;
wherein the rear edge of the top side is hingedly affixed to the rear edge of the bottom side, the bottom edge of the speaker enclosure is hingedly affixed to the front edge of the bottom side, and the top edge of the speaker enclosure is slideably engaged with the top side, forming a hinged clutch, the hinged clutch having a left side and a right side and an interior space;
wherein the first flexible side wing is generally disposed along the left side of the hinged clutch, the first flexible side wing being affixed along the left edge of the top side and along the left edge of the bottom side, forming a first flexible interface that is generally adjacent and parallel to the left edge of the speaker enclosure;
wherein the second flexible side wing is generally disposed along the right side of the hinged clutch, the second flexible side wing being affixed along the right edge of the top side and along the right edge of the bottom side, forming a second flexible interface that is generally adjacent and parallel to the right edge of the speaker enclosure; and
wherein the speaker enclosure includes at least one firing port, the at least one firing port being directed into the interior space of the hinged clutch, and the at least one speaker being positioned on a side of the speaker enclosure opposite the side of the at least one firing port.

2. The clutch speaker system of claim 1, wherein the hinged clutch is spring loaded.

3. The clutch speaker system of claim 2, where a clasp is affixed to the front edge of either of the top side or the bottom side.

4. The clutch speaker system of claim 3, further comprising at least one audio input port.

5. The clutch speaker system of claim 4, wherein the speaker enclosure includes two speakers.

6. The clutch speaker system of claim 5, further comprising at least one audio output port.

7. The clutch speaker system of claim 5, wherein the first flexible side wing and the second flexible side wing are comprised of plastic.

8. The clutch speaker system of claim 5, wherein the first flexible side wing and the second flexible side wing are comprised of leather.

9. The clutch speaker system of claim 5, wherein the top side and the bottom side are comprised of plastic.

10. The clutch speaker system of claim 5, wherein the top side and the bottom side are comprised of metal.

11. The clutch speaker system of claim 5, wherein a powered amplifier is attached to the hinged clutch and located within the interior space of the hinged clutch.

12. The clutch speaker system of claim 11, wherein the powered amplifier is connected to the two speakers.

13. A clutch speaker system comprising:
a top side, having a front edge, a rear edge, a right edge, and a left edge;
a bottom side, having a front edge, a rear edge, a right edge, and a left edge;
a speaker enclosure, including at least one speaker, the speaker enclosure having a top edge, a bottom edge, a right edge, and a left edge;
wherein the rear edge of the top side is hingedly affixed to the rear edge of the bottom side, the bottom edge of the speaker enclosure is hingedly affixed to the front edge of the bottom side, and the top edge of the speaker enclosure is slideably engaged with the top side, forming a hinged clutch, the hinged clutch having a left side and a right side and an interior space.

14. The clutch speaker system of claim 13 further comprising a first flexible side wing and a second flexible side wing.

15. The clutch speaker system of claim 14, where a clasp is affixed to the front edge of either of the top side or the bottom side.

16. The clutch speaker system of claim 15, wherein the hinged clutch is spring loaded.

17. The clutch speaker system of claim 16, wherein the speaker enclosure includes two speakers.

18. The clutch speaker system of claim 17, wherein a powered amplifier is attached to the hinged clutch and located within the interior space of the hinged clutch.

19. The clutch speaker system of claim 18, wherein the powered amplifier is connected to the two speakers.
